(19) United States
(12) Patent Application Publication
(10) Pub. No.: US 2024/0149688 A1
(43) Pub. Date: May 9, 2024

(54) CONTROL SYSTEM, METHOD, AND APPARATUS FOR VEHICLE-MOUNTED DEVICE, DEVICE, AND STORAGE MEDIUM

(71) Applicant: XIAO-I PLUS INC., Wilmington, DE (US)

(72) Inventors: Jie CHENG, Wilmington, DE (US); Yangqing PU, Wilmington, DE (US)

(73) Assignee: XIAO-I PLUS INC., Wilmington, DE (US)

(21) Appl. No.: 18/416,070

(22) Filed: Jan. 18, 2024

Related U.S. Application Data
(63) Continuation of application No. PCT/IB2023/060200, filed on Oct. 11, 2023.

(51) Int. Cl. B60K 35/80; B60K 35/10; G07C 5/00

(52) U.S. Cl. CPC B60K 35/80; B60K 35/10; G07C 5/008; B60K 2360/148; B60K 2360/589

(57) ABSTRACT

Disclosed are a control system, a method, and an apparatus for a vehicle-mounted device, a device, and a storage medium. The control system includes a control device and vehicle-mounted terminal provided on a vehicle; where the control device is configured to receive a control message from a first user terminal, determine a vehicle-end task matched with the control message, and send information of the vehicle-end task to the vehicle-mounted terminal; and the vehicle-mounted terminal is configured to determine, based on received information of the vehicle-end task, a target vehicle-mounted device executing the vehicle-end task from a vehicle-mounted device provided on the vehicle, and trigger the target vehicle-mounted device to execute the vehicle-end task.

### CROSS-REFERENCE TO RELATED APPLICATIONS

This application is a continuation of International Application No. PCT/I132023/060200, filed on Oct. 11, 2023, the disclosure of which is hereby incorporated by reference in its entirety.

### TECHNICAL FIELD

The present disclosure relates to the field of vehicle control technologies, and in particular, to a control system, a method, and an apparatus for a vehicle-mounted device, a device, and a storage medium.

### BACKGROUND

With continuous development of science and technology and acceleration of urbanization, rapid development is achieved in automobile industry. It follows that vehicle-mounted devices are increasingly diversified. A wide variety of vehicle-mounted devices not only enrich driving experience of ordinary drivers, but also provide professionals who utilizes special vehicles to implement tasks with guarantee. For example, a police vehicle may be equipped with a license plate capture device, a speed measurement device and the like. A field rescue vehicle may be equipped with a power generating equipment, an electric traction equipment and the like. However, currently, these vehicle-mounted devices are still relying on manual operations. For example, a vehicle-mounted device needs to be started through a switch or an operating button provided on the vehicle-mounted device. Obviously, no matter for ordinary drivers or professionals who execute professional tasks, there are problems of inconvenience in operating and poor interactivity in the vehicle-mounted devices.

### SUMMARY

In view of this, embodiments of the present disclosure provide a control system, a method, and an apparatus for a vehicle-mounted device, a device, and a storage medium, so as to simplify user operation and enhance intelligent interactivity of the vehicle-mounted device.

In a first aspect, an embodiment of the present disclosure provides a control system for a vehicle-mounted device, including: a control device and a vehicle-mounted terminal provided on a vehicle;
where the control device is configured to receive a control message from a first user terminal, determine a vehicle-end task matched with the control message, and send information of the vehicle-end task to the vehicle-mounted terminal; and
the vehicle-mounted terminal is configured to determine, based on the information of the vehicle-end task received from the control device, a target vehicle-mounted device for executing the vehicle-end task from vehicle-mounted devices provided on the vehicle, and trigger the target vehicle-mounted device to execute the vehicle-end task.

In the embodiment of the present disclosure, the vehicle-mounted terminal is further configured to acquire an execution result of the vehicle-end task, and return the execution result to the control device; and
the control device is further configured to acquire the execution result of the vehicle-end task returned by the vehicle-mounted terminal, and return the execution result to the first user terminal and/or send the execution result to a security database for storage.

In the embodiment of the present disclosure, the control device is further configured to send the execution result to the security database storing blacklist data for matching, and send a matching result, between the execution result and the blacklist data, returned by the security database to the first user terminal.

In the embodiment of the present disclosure, the control device is further configured to determine, based on the execution result, whether to trigger other vehicle-end tasks, and send, when the other vehicle-end tasks are determined to be triggered, information of another vehicle-end task triggered to the vehicle-mounted terminal.

In the embodiment of the present disclosure, the control device is started along with a start of an engine of the vehicle, and maintains in a running state.

In the embodiment of the present disclosure, the control device is further configured to receive a query message from a second user terminal; send a query request to the security database based on a query condition included in the query message; and return a query result acquired from the security database to the second user terminal.

In the embodiment of the present disclosure, the control device and the first user terminal interact with each other through a dedicated communication network.

In the embodiment of the present disclosure, the vehicle is a special vehicle; and the vehicle-end task includes one or more of a data acquisition task, a recording task, a traffic control task, a detection task, a warning task, a communication task, and a rescue task;
where a target vehicle-mounted device corresponding to the data acquisition task includes a vehicle-mounted sensor device;
a target vehicle-mounted device corresponding to the recording task includes a vehicle-mounted recording device;
a target vehicle-mounted device corresponding to the traffic control task includes a vehicle-mounted traffic control device;
a target vehicle-mounted device corresponding to the detection task includes a vehicle-mounted detection device;
a target vehicle-mounted device corresponding to the warning task includes a vehicle-mounted warning device;
a target vehicle-mounted device corresponding to the communication task includes a vehicle-mounted communication device; and
a target vehicle-mounted device corresponding to the rescue task includes a vehicle-mounted rescue device.

According to a second aspect, an embodiment of the present disclosure provides a control method for a vehicle-mounted device, applied to a control device included in a control system, where the control device is provided on a vehicle, the control system further includes a vehicle-mounted terminal provided on the vehicle, and the method includes:
determining, in response to a control message from the first user terminal, a vehicle-end task matched with the control message; and
sending information of the vehicle-end task to the vehicle-mounted terminal, so that the vehicle-mounted terminal determines, based on the information of the vehicle-end task received form the control device, a target vehicle-mounted device from vehicle-mounted devices provided on the vehicle, and triggers the target vehicle-mounted device to execute the vehicle-end task.

In the embodiment of the present disclosure, the determining, in response to a control message from the first user terminal, a vehicle-end task matched with the control message includes:
acquiring, in response to a voice message from the first user terminal, a text obtained by performing voice recognition on the voice message, parsing a keyword from the text, and determining the vehicle-end task matched with the keyword; or
parsing, in response to a text message from the first user terminal, a keyword from the text message, and determining the vehicle-end task matched with the keyword.

In the embodiment of the present disclosure, the sending information of the vehicle-end task to the vehicle-mounted terminal includes:
waking up the vehicle-mounted terminal when the vehicle-mounted terminal is in a sleep state, and sending the information of the vehicle-end task to the vehicle-mounted terminal; or directly sending the information of the vehicle-end task to the vehicle-mounted terminal when the vehicle-mounted terminal is not in the sleep state;
where the information of the vehicle-end task includes a parameter of the vehicle-end task and information of the vehicle-mounted terminal executing the vehicle-end task.

In the embodiment of the present disclosure, the method further includes:
acquiring an execution result of the vehicle-end task from the vehicle-mounted terminal; and
returning the execution result to the first user terminal and/or sending the execution result to a security database for storage.

In the embodiment of the present disclosure, the method further includes:
sending the execution result to the security database for matching, where blacklist data is stored in the security database, and sending a matching result, between the execution result and the blacklist data, returned by the security database to the first user terminal.

In the embodiment of the present disclosure, the method further includes:
determining, based on the execution result, whether to trigger other vehicle-end tasks, and sending, when the other vehicle-end tasks are determined to be triggered, information of another vehicle-end task triggered to the vehicle-mounted terminal.

In the embodiment of the present disclosure, the determining, based on the execution result, whether to trigger other vehicle-end tasks includes:
performing matching on the execution result in the security database to obtain a matching result; and
determining to trigger another vehicle-end task when the matching result meets a trigger condition of the another vehicle-end task; or determining not to trigger other vehicle-end tasks when the matching result does not meet any trigger condition of other vehicle-end tasks.

In the embodiment of the present disclosure, the method further includes:
sending, in response to a query message from a second user terminal, a query request to the security database, where the query message includes a query condition;
acquiring a query result returned by the security database; and
returning the query result to the second user terminal.

In the embodiment of the present disclosure, the vehicle is a special vehicle; and the vehicle-end task includes one or more of a data acquisition task, a recording task, a traffic control task, a detection task, a warning task, a communication task, and a rescue task, where
a target vehicle-mounted device corresponding to the data acquisition task includes a vehicle-mounted sensor device;
a target vehicle-mounted device corresponding to the recording task includes a vehicle-mounted recording device;
a target vehicle-mounted device corresponding to the traffic control task includes a vehicle-mounted traffic control device;
a target vehicle-mounted device corresponding to the detection task includes a vehicle-mounted detection device;
a target vehicle-mounted device corresponding to the warning task includes a vehicle-mounted warning device;
a target vehicle-mounted device corresponding to the communication task includes a vehicle-mounted communication device; and
a target vehicle-mounted device corresponding to the rescue task includes a vehicle-mounted rescue device.

According to a third aspect, an embodiment of the present disclosure provides a control apparatus for a vehicle-mounted device, applied to a control system of the vehicle-mounted device, where the control system includes a control device and a vehicle-mounted terminal provided on a vehicle, and the control apparatus includes:
an interactive gateway unit, configured to receive a control message from a first user terminal; and
a service control unit, configured to determine, based on the control message, a vehicle-end task matched with the control message; and send information of the vehicle-end task to the vehicle-mounted terminal, so that the vehicle-mounted terminal determines, based on the information of the vehicle-end task, a target vehicle-mounted device from vehicle-mounted devices provided on the vehicle, and triggers the target vehicle-mounted device to execute the vehicle-end task.

According to a fourth aspect, an embodiment of the present disclosure provides an electronic device, including at least one memory and at least one processor, where the memory stores one or more computer instructions, and the one or more computer instructions are executed by the processor to implement the control method for the vehicle-mounted device as described above.

According to a fifth aspect, an embodiment of the present disclosure provides a non-transitory storage medium, where one or more computer instructions are stored in the non-transitory storage medium for implementing the control method for the vehicle-mounted device as described above.

The technical solution of embodiments of the present disclosure has the following advantages.

According to the embodiments of the present disclosure, a control device is added to a vehicle. After a control message of a first user terminal is received by the control device, the control device determines a vehicle-end task matched with the control message, and sends information of the vehicle-end task to a vehicle-mounted terminal. The vehicle-mounted terminal determines a target vehicle-mounted device for executing the vehicle-end task from vehicle-mounted devices provided in the vehicle, and triggers the target vehicle-mounted device to execute the vehicle-end task. It can be seen that a user only needs to input the control message through the first user terminal, then control of the vehicle-mounted device at a remote end may be realized without manual operations on the vehicle-mounted device, thereby simplifying user operations and enhancing intelligent interactivity of the vehicle-mounted device.

### BRIEF DESCRIPTION OF THE DRAWINGS

In order to more clearly illustrate embodiments of the present disclosure or technical solutions in conventional technology, a brief introduction will be given to accompanying drawings required in the embodiments. Obviously, the accompanying drawings in the following description are only some embodiments of the present disclosure. For those skilled in the art, other accompanying drawings may be further obtained based on these drawings without any creative effort.

FIG. 1 is a schematic diagram of a system architecture according to an embodiment of the present disclosure.

FIG. 2 is a schematic structural diagram of a form of an electronic device adopted by a control device according to an embodiment of the present disclosure.

FIG. 3 is a flowchart of a control method for a vehicle-mounted device according to an embodiment of the present disclosure.

FIG. 4 is another flowchart of a control method for a vehicle-mounted device according to an embodiment of the present disclosure.

FIG. 5 is a schematic diagram of a scenario of an application example according to an embodiment of the present disclosure.

FIG. 6 is a schematic diagram of a scenario of another application example according to an embodiment of the present disclosure.

FIG. 7 is a schematic block diagram of a control apparatus according to an embodiment of the present disclosure.

FIG. 8 is a schematic block diagram of an apparatus provided on a vehicle-mounted terminal according to an embodiment of the present disclosure.

### DETAILED DESCRIPTION OF THE EMBODIMENTS

Technical solutions in embodiments of the present disclosure are clearly and completely described below with reference to accompanying drawings in the embodiments of the present disclosure. Obviously, the described embodiments are only a part of the embodiments of the present disclosure, but are not all embodiments. All other embodiments obtained by a person of ordinary skill in the art based on the embodiments of the present disclosure fall within protection scope of the present disclosure.

Terms used in the embodiments of the present disclosure are for a purpose of describing particular embodiments only, and are not intended to limit the present disclosure. Singular forms of “one”, “said”, and “the” used in the embodiments of the present disclosure and accompanying claims are also intended to include plural forms, unless context clearly indicates other meanings.

It should be understood that term “and/or” used herein is merely an association relationship describing associated objects, and indicates that there may be three types of relationships. For example, A and/or B may indicate that A exists alone, A and B exist at the same time, and B exists alone. In addition, character “/” in the specification generally indicates that a relationship between preceding and following objects is an “or”.

As described in the background, the vehicle-mounted devices in conventional technology still rely on manual operations, because each vehicle-mounted device is in a static state, and not capable of working without manual operations. In view of this, embodiments of the present disclosure provide a new idea. A control device is added to a vehicle, and linkage control over a vehicle-mounted device is realized through the control device and a vehicle-mounted terminal.

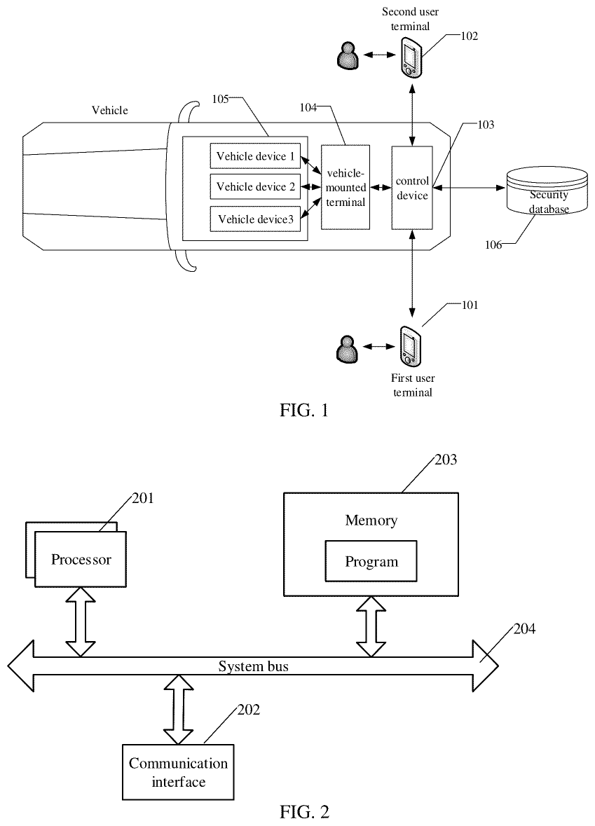

FIG. 1 shows an exemplary system architecture that may apply an embodiment of the present disclosure. As shown in FIG. 1, the entire system architecture includes a user terminal (based on different effects, taking a first user terminal 101 and a second user terminal 102 as an example in FIG. 1), a vehicle-mounted device 105 (based on different types, taking vehicle-mounted devices 1 to 3 as an example in FIG. 1), and a control system for the vehicle-mounted devices provided in the embodiment of the present disclosure, and may further include a security database 106 located at a server side. The control system includes: a control device 103 and a vehicle-mounted terminal 104 provided on the vehicle.

The user terminal provided in the embodiment of the present disclosure may include, but is not limited to, a mobile phone, a tablet computer, a laptop, a Personal Digital Assistant (PDA), a wearable device, and the like. The wearable device may include, for example, a smart watch, smart glasses, a smart bracelet, and the like.

It should be noted that definitions of “first”, “second”, and the like involved in the present disclosure are not limited in terms of size, order, number, and the like, and are only used to distinguish between names. For example, “first user terminal” and “second user terminal” are only used to distinguish between two user terminals in terms of name.

The first user terminal 101 is configured to send a control message to the control device 103. That is, a user may input the control message to the control device 103 by means of the first user terminal 101, and then the control message is sent to the control device 103.

Therein, the user may use a specific client, or open a specific page through a browser, or use a specific applet and the like to send the control message to the control device 103.

The control message may be a text message, and may also be a voice message. For example, a text such as “perform a speed measurement”, “capture a license plate” and the like may be input by the user and then text message is sent to the control device 103 by the first user terminal 101. For another example, a voice such as “perform a speed measurement” and “capture a license plate” may be input by the user and then voice message is sent to the control device 103 by the first user terminal 101.

The control device 103 may be configured to receive the control message from the first user terminal 101, determine a vehicle-end task matched with the control message, and send information of the vehicle-end task to the vehicle-mounted terminal 104.

In the system architecture shown in FIG. 1, the control device 103, the vehicle-mounted terminal 104, and the vehicle-mounted device 105 are provided on the same vehicle. The control device 103 may be configured as a box with a communication function and a task allocation function. On the one hand, the control device 103 is responsible for communicating with the user terminal (including the first user terminal 101 and the second user terminal 102), the vehicle-mounted terminal 104, and the security database 106, and on the other hand, the control device 103 is responsible for allocating related vehicle-end tasks.

As an implementation, the above-mentioned control device 103 may be implemented as an electronic device. As shown in FIG. 2, the electronic device may include: at least one processor 201, at least one communication interface 202, at least one memory 203, and at least one communication bus 204.

In this embodiment, the number of the processor 201, the communication interface 202, the memory 203, and the communication bus 204 is at least one respectively, and the processor 201, the communication interface 202, and the memory 203 may communicate with each other through the communication bus 204.

A communication interface 202 may be an interface of a communication module for network communication. In the embodiment of the present disclosure, the communication interface 202 is a communication interface for the user terminal, the vehicle-mounted terminal 104, and the security database 106.

The processor 201 may be a Central Processing Unit (CPU), or an Application Specific Integrated Circuit (ASIC), or one or any combination of dedicated processors (such as an image processor, an application processor, a baseband processor, and the like).

The memory 203 may include a high-speed Random Access Memory (RAM), and may further include a non-volatile memory, such as at least one magnetic disk memory.

Therein, one or more computer instructions are stored in the memory 203, and the one or more computer instructions are executed by the processor 201 to implement the control method provided in the embodiments of the present disclosure, that is, the control method executed by the control device 103. The control method will be described in detail in the following embodiments.

The control device 103 in the system architecture shown in FIG. 1 may be disposed at a specific position in the vehicle, for example, disposed at positions such as a trunk, a vehicle chassis and the like.

As an implementation, the control device 103 may be started along with a start of a vehicle engine and maintain in a running state. For example, during a starting process of the vehicle engine, the control device 103 is powered up to trigger the control device 103 to start, and the control device 103 maintains in the running state after being started, so that the control message from the first user terminal 101 is monitored at any time.

As another implementation, the control device 103 may also be started after being triggered by a user and maintain in the running state. For example, a switch connected to the control device 103 is triggered by the user, thereby powering up the control device 103 to trigger the control device 103 to start and maintain in the running state. The control device 103 may alternatively be started in other manners, and other manners are not listed here.

The vehicle-mounted terminal 104 in the system architecture shown in FIG. 1 refers to a computer terminal mounted on the vehicle, which is usually provided with an independent operating system, a processor, and a memory so that a plurality of programs may be installed and run to implement processing of the vehicle-mounted terminal 104. The vehicle-mounted terminal 104 may further be provided with an image output device such as a display screen and a sound output device such as a megaphone.

In the embodiment of the present disclosure, the vehicle-mounted terminal 104 may be configured to determine, based on the information of the vehicle-end task received from the control device 103, a target vehicle-mounted device 105 for executing the vehicle-end task from vehicle-mounted devices 105, and trigger the target vehicle-mounted device 105 to execute the vehicle-end task.

A specific processing flow of the control device 103 and the vehicle-mounted terminal 104 will be described in detail in the following embodiments.

In the embodiment of the present disclosure, the control device 103 and the vehicle-mounted terminal 104 may interact with each other through a bus or a Near Field Communication (NFC) and the like.

The system architecture provided in the embodiment of the present disclosure may be applied to an ordinary vehicle, and may also be applied to a special vehicle. The special vehicle may include a police vehicle, a fire engine, an ambulance vehicle, a field rescue vehicle, a power emergency repair vehicle, a power erection vehicle, a telecommunication vehicle, and the like.

The above-mentioned vehicle-mounted device 105 refers to a device, an instrument, or a machine that is usually prepared for a specific purpose, which may be provided by a third party, or come with the vehicle itself. The vehicle-mounted device 105 may include, but is not limited to: a vehicle-mounted sensor device, a vehicle-mounted recording device, a vehicle-mounted traffic control device, a vehicle-mounted detection device, a vehicle-mounted warning device, a vehicle-mounted communication device, or a vehicle-mounted rescue device and the like.

Therein, the vehicle-mounted sensor device is mainly responsible for collecting environment information around the vehicle, and may include an image acquisition device such as a camera, a recorder, a snapshot device and the like, and may also include other sensor devices such as a vehicle-mounted radar, a vehicle-mounted infrared thermal imager and the like.

The vehicle-mounted recording device is mainly responsible for collecting sound information, and may include a microphone, a recording pen, a recorder and the like.

The vehicle-mounted traffic control device is mainly responsible for controlling a traffic facility. The traffic facility may include, for example, a traffic light, a smart display, a road lighting and the like. As an implementation, the vehicle-mounted traffic control device may output a Vehicle To Everything (V2X) traffic control signal to the outside, so as to control the traffic facility. Therein, V2X is a technology developed for intelligent transportation, and may enable a traffic facility such as a vehicle, a roadside device, a traffic management system and the like to exchange information in real time through the wireless communication technology, so that a safer and more intelligent traffic experience may be realized.

The vehicle-mounted detection device is mainly responsible for performing detection on specific information, and may include, for example, a speed measurement gun for detecting a driving speed of a vehicle, a vehicle-mounted electric field detector (usually used for a fire truck) for detecting an electric field, a gas detector and the like.

The vehicle-mounted warning device is mainly responsible for outputting warning information, and the warning information may include a variety of forms such as light, sound and the like. The vehicle-mounted warning device may include, for example, a warning light, a signal light, a horn and the like.

The vehicle-mounted communication device is mainly responsible for performing a specific form of communication with the outside, and may include, for example, a radio station, a broadcast, a walkie talkie and the like.

The vehicle-mounted rescue device is mainly used to provide an emergency rescue function, and may include, for example, an oxygen generator, a ventilator, a power generation device, a lighting device, an electric traction winch, a lifting device and the like.

From the system architecture shown in FIG. 1, it may be seen that the control device 103, the vehicle-mounted terminal 104 and the vehicle-mounted device 105 are all provided on the same vehicle. The control message of the first user terminal 101 does not need to be issued by a cloud platform, and instead, is directly sent to the control device 103 through direct communication between the first user terminal 101 and the control device 103. Then, the vehicle-end tasks are allocated by the control device 103.

In order to ensure efficiency and security of communication between the first user terminal 101 and the vehicle, in the embodiment of the present disclosure, the first user terminal 101 and the control device 103 may interact with each other through a dedicated communication network. The so-called dedicated communication network refers to a telecommunication network built by a relevant department or unit for internal use due to a business need. For example, if the embodiment of the present disclosure is applied to a special vehicle, FirstNet, TETRA, and the like may be used for the above-mentioned dedicated communication network.

A full name of FirstNet is “First Responders Network”. FirstNet belongs to the field of emergency communication private networks, and is intended to solve a problem of “fighting independently and dividing boundaries” in emergency communication for police, traffic police, fire protection, medical and other public safety institutions. FirstNet is a nationwide wireless broadband network with a wide range, strong interoperability, high reliability and good scalability authorized by the United States Congress, and provides an efficient and reliable broadband wireless communication guarantee for command decision and on-site handling force in the field of public security.

A full name of TETRA is “Terrestral Trunked Radio”. TETRA is a wireless communication standard formulated by Europe Telecommunications Standards Institute (ETSI), and is a relatively popular police wireless communication system in Europe.

Compared to a method of issuing a task through a cloud platform, control efficiency of the method provided by the embodiment of the present disclosure is relatively higher, that is, faster interaction and control between the first user terminal 101 and the vehicle end may be realized, and security and reliability of interaction between the first user terminal 101 and the vehicle-end may be ensured by means of a dedicated communication network.

Furthermore, the above-mentioned control device 103 involved in the embodiment of the present disclosure may be designed as an encryption device, so that data stored in the control device 103 is difficult to be cracked and falsified by external devices, thereby further ensuring system security.

In addition, the control device 103 provided by the embodiment of the present disclosure may be equipped with a smart card reader or a biometric identity authentication unit, and the like. After the control device 103 is started up, functions of the control device 103 can only be enabled after a specific Integrated Circuit Card (IC Card) is read or pre-authenticated biometric information is input. The specific IC card is used by a user of a specific identity, or biometric information is collected and authenticated for the user of the specific identity in advance, thereby locking a security level of the user. Therein, the biometric information may include a fingerprint, an iris, a face, and the like. For example, for a control device 103 on a police vehicle, an IC card is provided for a specific police user, and the police user may only use the control device 103 by swiping the IC card on an intelligent reader on the control device 103. For another example, for a control device 103 on a police vehicle, a fingerprint of a specific police user is collected and authenticated in advance, and the police user may only use the control device 103 after the authenticated fingerprint is input into the control device 103.

The vehicle-mounted device 105 may further be configured to return an execution result of the vehicle-end task to the vehicle-mounted terminal 104. The vehicle-mounted terminal 104 may further be configured to acquire the execution result of the vehicle-end task and return the execution result to the control device 103.

Correspondingly, the control device 103 may further be configured to acquire the execution result of the vehicle-end task returned by the vehicle-mounted terminal 104, and return the execution result to the first user terminal 101 and/or send the execution result to the security database 106 for storage.

Therein, the execution result may be information indicating whether an execution is successful. In this case, the execution result is usually returned to the first user terminal 101. The user may learn an execution status of the vehicle-end task through the first user terminal 101, and the execution result may further be sent to the security database 106 as a log for recording.

If the task executed by the vehicle-mounted device 105 is a data acquisition task, a recording task, a detection task, or the like, the execution result may include data collected by the vehicle-mounted device 105, such as recording data, a detection result and the like. In this case, the execution result may be returned to the first user terminal 101, and the execution result may further be sent to the security database 106 for storage.

In the embodiment of the present disclosure, the security database 106 may be a database disposed at a server side. Blacklist data may be stored in the security database 106. For example, license plate information captured by a vehicle-mounted capture device may be matched in the security database 106, where blacklist data is stored and includes license plate information with a suspected or recorded violation. An obtained matching result may be returned to the first user terminal 101, and a policeman using the first user terminal 101 may timely determine whether the vehicle captured has a suspected or recorded violation and take a corresponding action. For another example, portrait information photographed by the vehicle-mounted camera device may be matched in the security database 106, where blacklist is stored and includes face information with a suspected or recorded violation. A matching result may be returned to the first user terminal 101, and a policeman using the first user terminal 101 may timely determine whether a photographed person is a fugitive and take a corresponding action. For another example, after vehicle speed information is detected by a vehicle-mounted speed measurement gun, the vehicle speed information may be matched in the security database 106, where blacklist data is stored and includes overspeed information corresponding to each road section, for example, a speed limit of a road section is 60 km/h, and then vehicle speed exceeding 60 km/h is the blacklist data. Matching data obtained may be returned to the first user terminal 101, and a policeman using the first user terminal 101 may timely obtain information on whether a vehicle is overspeed.

Furthermore, a user may send a query message to the control device 103 through the second user terminal 102 to implement a query access to the security database 106. As an implementation, the user may send a query message to the control device 103 through the second user terminal 102, and the query message includes a query condition. The query condition may include, for example, a time condition, a keyword, and the like. The control device 103 sends a query request to the security database 106 based on the query condition. After a query is performed by the security database 106 based on the query request, the security database 106 returns an obtained query result to the control device 103, and the control device 103 returns the query result to the second user terminal 102. Through this process, a user may query data of the security database 106 through the second user terminal 102 and the control device 103. A query may be performed for a log containing an execution result, or may be performed for other content (such as blacklist data . . . ) in the security database 106

Considering that the execution result of the vehicle-end task may involve information such as user privacy which may be acquired only by a professional institution (for example, a police agency, a court agency, a procuratorate agency and the like), during an interaction between the control device 103 and the security database 106, a technology such as an encryption algorithm, identity verification and access control are adopted to ensure security of the database, and only a specific control device (such as a control device preset on a police vehicle) can access the security database 106.

For example, a key and an encryption algorithm for interacting with a security database 106 are preset in the control device 103. When accessing the security database 106, the control device 103 uses the preset key and encryption algorithm for encryption and carries identity information of the control device 103 to access the security database 106. After decryption is performed by the security database 106, the identity information of the control device 103 is verified, and the control device 103 is allowed to access after a verification is passed. Therein, the access to the security database 106 may include sending an execution result to the security database 106 for storage, sending the execution result to the security database 106 for matching, sending a query request to the security database 106, and the like, as mentioned in the above embodiments.

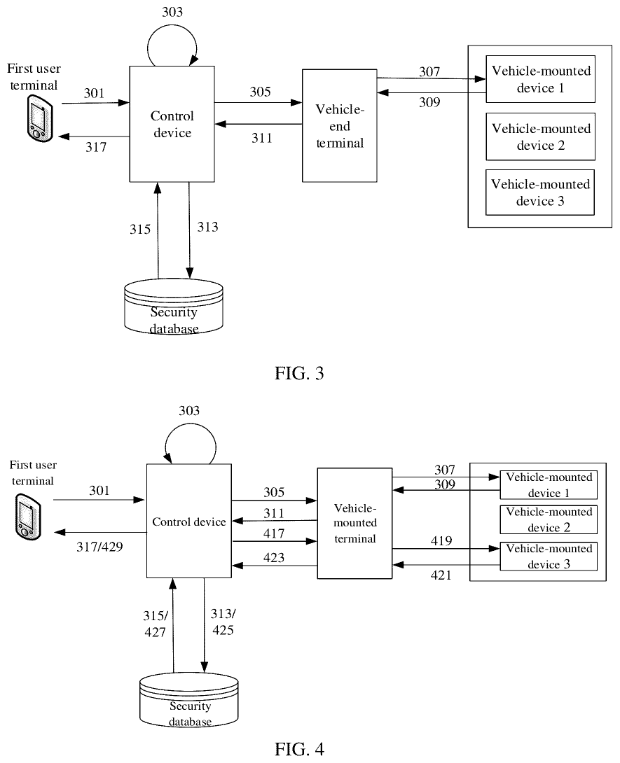

Based on the above-mentioned system, specific method flows executed by the control device 103 and the vehicle-mounted terminal 104 will be described in detail in the following. FIG. 3 is a flowchart of a control method for a vehicle-mounted device according to an embodiment of the present disclosure, and is applied to the system architecture shown in FIG. 1. As shown in FIG. 3, the control method may include the following steps.

Step 301: receiving a control message from a first user terminal by a control device.

A user may use a specific client on the first user terminal, or open a specific page through a browser, or use a specific applet and the like to send a control message to the control device. The sent control message may be a text message, or may be a voice message.

Step 303: determining, in response to the control message from the first user terminal, a vehicle-end task matched with the control message.

In response to the voice message from the first user terminal, the control device may acquire a text obtained by performing voice recognition on the voice message, parse a keyword from the text, and determine a vehicle-end task matched with the keyword. In response to the text message from the first user terminal, the control device may parse a keyword from the text message to determine the vehicle-end task matched with the keyword.

In the embodiment of the present disclosure, a corresponding relationship between a keyword and a vehicle-end task may be pre-configured in the control device. For example, keywords “capture”, “license plate” and the like are configured to correspond to a capture task of a capture device. When a user sends a voice message or a text message containing an instruction such as “capture” and “license plate” to the control device, the capture task may be triggered. A user may alternatively send a natural language voice message or text message such as “take a picture of the license plate immediately” to the control device. The control device may parse the natural language message by using a natural language processing technology such as a dictionary, a language model such as N-grams, or an intention analysis model and the like, and determine a corresponding relationship between a parsed keyword (for example, “license plate”) and a vehicle-end task, thereby triggering the capture task.

For another example, keywords “measuring speed” and “vehicle speed” are configured to correspond to a speed measurement task of a speed measurement gun. When a user sends a text message or a voice message containing an instruction such as “speed measurement” to the control device, the speed measurement task may be triggered. A user may alternatively send a natural language voice message or text message such as “measure the vehicle speed” to the control device. Then, the control device may parse the natural language message by using the natural language processing technology such as the dictionary, the language model such as N-grams, or the intention analysis model, and determine a corresponding relationship between a parsed keyword (for example, “vehicle speed”) and a vehicle-end task, thereby triggering the speed measurement task.

Step 305: sending information of the vehicle-end task determined to a vehicle-mounted terminal by the control device.

Processing performed by the vehicle-mounted terminal in the embodiment of the present disclosure may be implemented by a client provided on the vehicle-mounted terminal, and the client may be implemented by an Artificial Intelligence (AI) assistant, an Artificial Intelligence (AI) robot and the like. The vehicle-mounted terminal or the client is usually in a sleep state without a task for a long time. Therefore, if the vehicle-mounted terminal or the client is in the sleep state, the control device may first execute a wake-up processing to wake up the client of the vehicle-mounted terminal or the vehicle-mounted terminal, and then send the information of the vehicle-end task to the vehicle-mounted terminal. Otherwise, the information of the vehicle-end task is directly sent to the vehicle-mounted terminal.

As an implementation, the information of the vehicle-end task may include information indicating a type of the vehicle-end task, for example, information indicating a license plate capture task, a speed measurement task, a gas detection task, a police communication task, or the like.

Step 307: determining, based on the information of the vehicle-end task received from the control device, a target vehicle-mounted device from the vehicle-mounted device provided on a vehicle, and triggering the target vehicle-mounted device to execute the vehicle-end task by the vehicle-mounted terminal.

For example, the information of the vehicle-end task includes information indicating the type of the vehicle-end task, and the vehicle-mounted terminal may determine, based on the information indicating the type of the vehicle-end task, the target vehicle-mounted device from the vehicle-mounted device provided in the vehicle. For example, a corresponding relationship between a task type and a vehicle-mounted device is pre-configured in the vehicle-mounted terminal, and the vehicle-mounted terminal determines a target vehicle-mounted device based on the corresponding relationship.

In the embodiment of the present disclosure, a driver corresponding to each vehicle-mounted device may be preset in the vehicle-mounted terminal. After the vehicle-mounted terminal determines the target vehicle-mounted device, a driver corresponding to the target vehicle-mounted device is called to set a parameter on the target vehicle-mounted device, and the set parameter is used for the target vehicle-mounted device to execute the corresponding vehicle-end task.

Step 309: acquiring an execution result of the vehicle-end task from the vehicle-mounted device by the vehicle-mounted terminal.

In the embodiments of the present disclosure, the execution results may vary depending on a type of the vehicle-mounted device. For example, corresponding to that the vehicle-mounted device is a vehicle-mounted sensor device that performs a data acquisition task, or a vehicle-mounted recording device that executes a recording task, or a vehicle-mounted detection device that executes a detection task, the execution result generated accordingly may be acquired data, or recording data, or a detection result. For another example, in general, the vehicle-mounted device may also generate an execution result indicating whether an execution was successful.

Step 311: returning the execution result to the control device by the vehicle-mounted terminal.

Step 313: sending, by the control device, the execution result to a security database for matching.

As an implementation, blacklist data may be stored in the security database, and when the blacklist data is applied to different application scenarios, the content of the blacklist data may be different.

For example, an above-mentioned security database may pre-store information such as license plate information and face information of suspected individuals, fugitives, or the like. The control device may send an execution result including a captured license plate or a captured facial image to the security database. Then it may be determined whether the license plate is a license plate of a fugitive, a suspected person and the like by matching the license plate with the blacklist data in the security database. After a matching result is returned to a police user, the police user may determine whether to take action in time based on the matching result.

For another example, speed limit information corresponding to each road section may be stored in the security database in advance. The control device may send an execution result of vehicle speed information (information of a vehicle location is further included) obtained by a speed measuring device to the security database. Then it may be determined whether overspeed occurs by matching the vehicle speed information with the blacklist data in the security database. After a matching result is returned to a police user, the police user may determine whether to perform a punishment or the like.

In addition to the blacklist data used for matching in the security database, the security database may further store other content for matching, without further listing here.

Step 315: acquiring a matching result from the security database by the control device.

Step 317: sending the matching result to the first user terminal.

As another implementation, in addition to sending the execution result to the security database for matching in a manner shown in Step 313 and Step 315, the control device may also not perform Step 313 and Step 315, but send the execution result to the security database for storage.

As yet another implementation, the control device may further send the execution result to the security database for storage while performing Step 313 and Step 315. That is, on the one hand, the security database may perform matching on the execution result, and on the other hand, the security database may store the execution result.

As yet another implementation, the control device may not perform Step 313, Step 315 and Step 317 described above, but directly return the execution result to the first user terminal.

As yet another implementation, the control device may not perform Step 313, Step 315 and Step 317 described above, but return the execution result to the first user terminal, and provide the execution result to the security database for storage.

According to the method provided in the embodiment shown in FIG. 3, the user may send the control message to the control device 103 through the first user terminal 101, thereby realizing intelligent control of the vehicle-mounted device. In addition, linkage control of a plurality of vehicle-mounted devices may further be realized. In this case, the control device 103 in the architecture shown in FIG. 1 may be further configured to determine, according to the execution result, whether to trigger other vehicle-end tasks and send information of another vehicle-end task triggered to the vehicle-mounted terminal 104 when the other vehicle-end tasks are determined to be triggered. It follows that the vehicle-mounted terminal 104 continues to determine, based on received information of the vehicle-end task, a target vehicle-mounted device, and triggers the target vehicle-mounted device to execute the corresponding vehicle-end task. After the vehicle-mounted terminal 104 acquires an execution result, the vehicle-mounted terminal 104 returns the execution result to the control device103, and the control device103 may continue to determine whether to trigger other vehicle-end tasks based on the execution result, and so on. In this way, linkage control of a plurality of vehicle-mounted devices is realized.

As an implementation, the processing of determining, based on the execution result, whether to trigger other vehicle-end tasks may be a process of determining, based on information that whether the vehicle-end task is successfully executed by the vehicle-mounted device, whether to trigger other vehicle-end tasks.

For example, a linkage relationship between a vehicle-mounted device 1 and a vehicle-mounted device 2 is pre-configured in the control device103, and the linkage relationship indicates that a vehicle-end task corresponding to the vehicle-mounted device 2 is triggered after a vehicle-end task corresponding to the vehicle-mounted device 1 is executed successfully. In this case, after the control device 103 obtains an execution result that the vehicle-end task corresponding to the vehicle-mounted device 1 is executed successfully, the control device103 sends task information corresponding to the vehicle-mounted device 2 to the vehicle-mounted terminal 104.

For another example, a linkage relationship between the vehicle-mounted device 1 and a vehicle-mounted device 3 is pre-configured in the control device103, and the linkage relationship indicates that a vehicle-end task corresponding to the vehicle-mounted device 3 is triggered after an execution of the vehicle-mounted device 1 fails. In this case, after the control device103 obtains the execution result of the failed execution of the vehicle-mounted device 1, the control device103 sends task information corresponding to the vehicle-mounted device 3 to the vehicle-mounted terminal 104.

As another implementation, the processing of the determining, based on the execution result, whether to trigger other vehicle-end tasks may be a process including: sending the execution result to the security database for matching to obtain a matching result; determining to trigger other vehicle-end tasks when the matching result meets a trigger condition of the other vehicle-end tasks; determining that the other vehicle-end tasks are not triggered when the matching result does not meet a trigger condition of the other vehicle-end tasks. The control method flow corresponding to the implementation may be as shown in FIG. 4. The control method is different from the embodiment shown in FIG. 3 in that after Step 315 in the flow shown in FIG. 3 is executed, the following steps are then performed.

Step 417: determining whether the matching result obtained in Step 315 meets a trigger condition of other vehicle-end tasks by the control device, and if so, sending information of the other vehicle-end tasks to the vehicle-mounted terminal, and if not, executing Step 429, and returning the matching result to the first user terminal.

In the embodiment of the present disclosure, in addition to parsing a keyword in a control message as a trigger condition of a vehicle-end task, a matching result of other vehicle-end tasks may be configured in a control device as a trigger condition of a vehicle-end task. For example, a trigger condition of a vehicle-end task 2 may be configured to include that a matching result of a vehicle-end task 1 is matched to blacklist data. In this case, if an execution result of the vehicle-end task 1 matches the blacklist data in the security database, the vehicle-end task 2 is triggered, and the control device may continue to send information of the vehicle-end task 2 to the vehicle-mounted terminal.

Step 419: determining, based on received information of the vehicle-end task, a target vehicle-mounted device from the vehicle-mounted device provided on a vehicle and triggering the target vehicle-mounted device to execute the vehicle-end task by the vehicle-mounted terminal.

Step 421: acquiring an execution result of the vehicle-end task from the vehicle-mounted device by the vehicle-mounted terminal.

Step 423: returning the execution result to the control device by the vehicle-mounted terminal.

Step 425: sending, by the control device, the execution result to a security database for matching.

Step 427: acquiring a matching result from the security database by the control device.

Step 429: determining whether the matching result obtained in step 427 meets a triggering condition of other vehicle-end tasks by the control device, and if not, sending the matching result to the first user terminal.

A processing of Step 419 to Step 429 is similar to Step 307 to Step 317 in FIG. 3, and is not described in detail herein.

In addition, in the system architecture shown in FIG. 1, execution information of the vehicle-end task may be prompted on the vehicle-mounted terminal 104, which may include, for example, one or any combination of a name, an execution stage, and an execution result of the vehicle-end task. The prompt message may be displayed on a screen of the vehicle-mounted terminal, or may be a voice prompt, and the like. Through the prompt of the vehicle-mounted terminal, a user located in a vehicle may learn an execution status of the vehicle-end task in time.

As mentioned in previous embodiments, the foregoing system and method provided in the embodiment of the present disclosure may be applied to a special vehicle or a general vehicle. A police vehicle and a fire truck are used as examples to enumerate several disclosure examples.

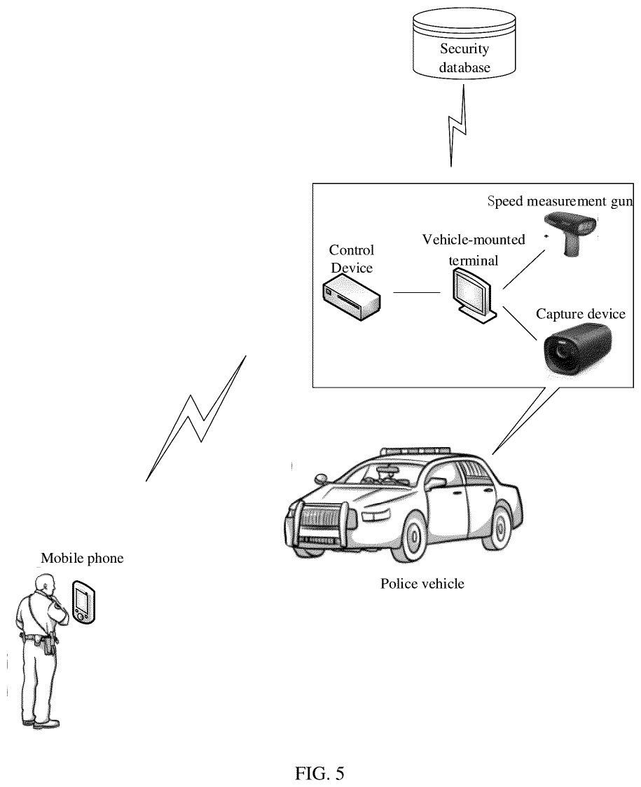

In an embodiment, a control device and a vehicle-mounted terminal are provided in a police vehicle shown in FIG. 5. The police vehicle is further equipped with a vehicle-mounted device such as a speed measurement gun, and a capture device. When a police user discovers a suspicious vehicle while performing work outside the police vehicle, if the police user returns to the vehicle and triggers the capture device to capture a license plate, a time delay may be caused, and the suspicious vehicle may not be captured in time. However, if the control method provided in the embodiment of the present disclosure is used, the police user only needs to quickly send a voice message “capture license plate” or “quickly take a photo of the license plate” through a mobile phone and the mobile phone sends the voice message to the control device in the police vehicle through a dedicated network such as FirstNet. After the control device acquires a text by performing voice recognition on the voice message, the control device parses a keyword “capture” or “license plate” corresponding to a capture task from the text, and sends information of the capture task to the vehicle-mounted terminal. The vehicle-mounted terminal determines, based on the information of the capture task, the capture device as a target vehicle-mounted device, and calls a driver of the capture device to perform parameter configuration on the capture device, so that the capture device is triggered to execute the capture task, and license plate information captured by the capture device is acquired. The vehicle-mounted terminal sends the captured license plate information to the control device, and the control device may send the license plate information to a security server. The security server matches the license plate information in a blacklist database and returns a matching result to the control device. The control device sends the matching result to the mobile phone. If the license plate is matched to a license plate of a fugitive, the police user may quickly pursue, based on the matching result, the vehicle corresponding to the license plate.

Obviously, in this embodiment, the police user may control the capture device in the police vehicle to capture a license plate and return a matching result only through a mobile phone, so that a work of the police user is efficiently and conveniently assisted, and intelligent interactivity of a vehicle-mounted device is greatly enhanced.

In another embodiment, a control device and a vehicle-mounted terminal are provided in a police vehicle shown in FIG. 5, and the police vehicle is further equipped with vehicle-mounted devices such as a speed measurement gun and a capture device. When a police user discovers a speeding vehicle while performing work outside the police vehicle, if the police user returns to the vehicle and triggers a speed measuring device for measuring, a time delay may be caused and speed measurement may not be performed in time. However, if the control method provided in the embodiment of the present disclosure is used, the police user only needs to quickly send a voice message “speed measurement” or “measure a vehicle speed” through a mobile phone and the mobile phone sends the voice message to the control device in the police vehicle through a dedicated network such as FirstNet. After the control device acquires a text by performing voice recognition on the voice message, the control device parses a keyword “speed measurement” or “vehicle speed” corresponding to a speed measurement task from the text, and sends information of the speed measurement task to the vehicle-mounted terminal. The vehicle-mounted terminal determines, based on the information of the speed measurement task, the speed measurement gun as a target vehicle-mounted device, and calls a driver of the speed measurement gun to perform parameter configuration on the speed measurement gun, so that the speed measurement gun is triggered to execute the speed measurement task, and vehicle speed information collected by the speed measurement gun is acquired. The vehicle-mounted terminal sends the vehicle speed information to the control device, and the control device may send the vehicle speed information and position information of the police vehicle (the position information may be acquired by invoking a Global Position System (GPS) in the vehicle) to a security server. The security server utilizes the position information of the police vehicle to match the speed measurement information with speed limit information of each road section and return a matching result to the control device. If the control device receives an overspeed matching result, a capture task may be triggered, and information of the capture task is sent to the vehicle-mounted terminal. The capture device is determined by the vehicle terminal as a target vehicle-mounted device for the capture task, and a driver of the capture device is called to trigger the capture device to capture a license plate. The vehicle-mounted terminal acquires a capture result of the capture device, that is, license plate information, and sends the license plate information to the security server. The security server matches the license plate information in a blacklist database and returns a matching result to the control device. The control device may send the matching results of the speed measurement task and the capture task to the mobile phone. In this way, the police user may determine, based on the matching results of the speed measurement task and the capture task, whether to take an action. For example, if the matching result is overspeed, a police user may issue a ticket for an overspeed vehicle. For another example, if the matching result is overspeed and a captured license plate belongs to a license plate of a fugitive, a police user may quickly pursue, based on the matching result, the vehicle corresponding to the license plate.

Obviously, in this embodiment, the speed measurement gun and the capture device in the police vehicle may be controlled to be associated with each other only through a mobile phone by the police user, that is, the speed measurement gun executes a speed measurement task and further triggers, based on the speed measurement result, the capture device, and quickly returns matching results of the two tasks, so that a work of the police user is efficiently and conveniently assisted, intelligent interactivity of a vehicle-mounted device is greatly enhanced, and linkage control of a plurality of vehicle-mounted devices is realized.

In still another embodiment, a control device and a vehicle-mounted terminal are provided in a police vehicle, and the police vehicle is further equipped with vehicle-mounted devices such as a capture device, and a communication device. When a police user discovers a suspicious vehicle while performing work outside the police vehicle, if the police user returns to the vehicle and triggers the capture device to capture a license plate, a time delay may be caused, and the suspicious vehicle may not be captured in time. However, if the control method provided in the embodiment of the present disclosure is used, the police user only needs to quickly send a voice message “capture license plate” or “quickly take a photo of the license plate” through a mobile phone and the mobile phone sends the voice message to the control device in the police vehicle through a dedicated network such as FirstNet. After the control device acquires a text by performing voice recognition on the voice message, the control device parses a keyword “capture” or “license plate” corresponding to a capture task from the text, and sends information of the capture task to the vehicle-mounted terminal. The vehicle-mounted terminal determines the capture device as a target vehicle-mounted device based on the information of the capture task, and calls a driver of the capture device to perform parameter configuration on the capture device, so that the capture device is triggered to execute the capture task, and license plate information captured by the capture device is acquired. The vehicle-mounted terminal matches the captured license plate information in a blacklist database, and if the captured license plate is matched to a license plate of a fugitive, the vehicle-mounted terminal may trigger a communication task and send information of the communication task to the vehicle-mounted terminal. On the one hand, the communication device is determined by the vehicle-mounted terminal as a target vehicle-mounted device for the communication task, and a driver of the communication device is called to trigger the communication device to send a matching result to other police vehicles. On the other hand, the control device sends the matching result to the mobile phone of the police user. In this way, the police user may quickly pursue, based on the matching result, the vehicle corresponding to the license plate, and the other police vehicles may also quickly assist according to the received matching result.

Obviously, in this embodiment, a capture device in the police vehicle may be controlled to capture a license plate only through a mobile phone by a police user, and to be linked with the a communication device. In this way, on the one hand, a matching result of the license plate is quickly returned, and on the other hand, the matching result is sent to other police vehicles. Therefore, a work of the police user is efficiently and conveniently assisted, intelligent interactivity of the vehicle-mounted device is greatly enhanced, linkage control of a plurality of vehicle-mounted devices is realized, and quick information synchronization among a plurality of police vehicles is realized.

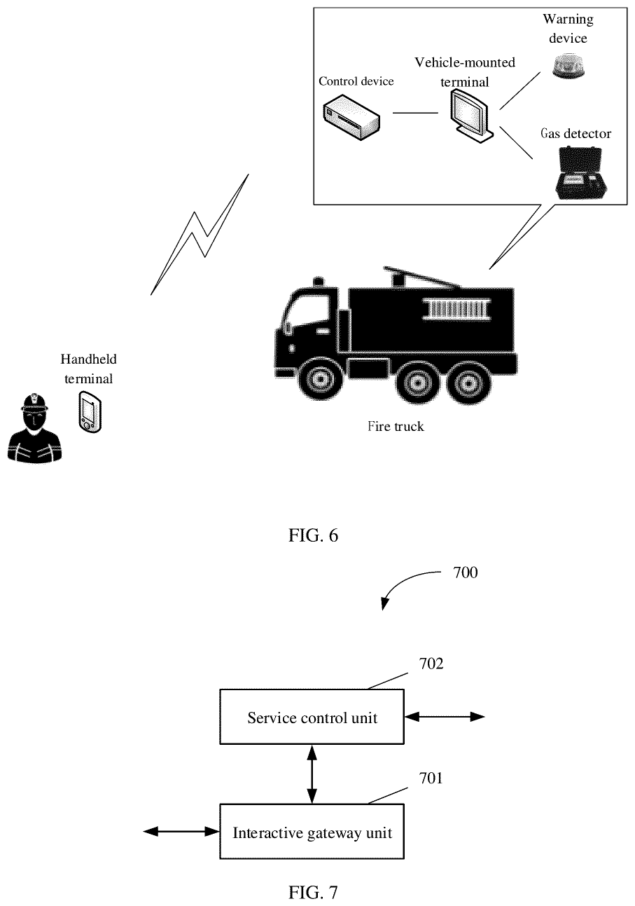

In yet still another embodiment, a control device and a vehicle-mounted terminal are provided in a fire truck shown in FIG. 6, and the fire truck is further equipped with vehicle-mounted devices such as a gas detector, and a warning device. When a firefighter notices an abnormal smell while performing a firefighting task outside the fire truck, if the firefighter returns to the truck and triggers the gas detector for detection, a time delay may be caused, and inconvenience caused by a firefighter wearable device and a handheld tool usually does not allow the firefighter to return to the truck for an operation. However, if the control method provided in the embodiment of the present disclosure is used, the firefighter only needs to quickly send a voice message “gas detection” or “measure gas concentration” through a handheld terminal and the handheld terminal sends the voice message to the control device in the fire truck through a dedicated network such as FirstNet. After the control device acquires a text by performing voice recognition on the voice message, the control device parses a keyword “gas detection” or “gas” corresponding a gas detection task from the text, and sends information of the gas detection task to the vehicle-mounted terminal. The vehicle-mounted terminal determines, based on the information of the gas detection task, the gas detector as a target vehicle-mounted device, and calls a driver of the gas detector to perform parameter configuration on the gas detector, so that the gas detector is triggered to execute the gas detection task, and gas concentration information collected by the gas detector is acquired. The vehicle-mounted terminal sends the gas concentration information to the control device, and the control device determines that the gas concentration exceeds a standard. On the one hand, the gas concentration information is returned to the handheld terminal, and on the other hand, a warning task is quickly triggered, and information of the warning task is sent to the vehicle-mounted terminal. The warning device is determined as a target vehicle-mounted device for the warning task by the vehicle-mounted terminal, and a driver of a warning device is called to trigger the warning device to warn. For example, a warning lamp is used for warning, or a prompt tone of a large sound volume is played for warning. The firefighter in this scenario may quickly learn that the gas concentration exceeds the standard and take a corresponding action.

Obviously, in this embodiment, a gas detector and a warning device in a fire truck may be controlled to be associated with each other only through a handheld terminal by a firefighter. That is, the gas detector executes a gas detection task, a gas detection result further triggers a warning task, and the detection result is quickly returned to the firefighter so that a warning is provided for all firefighters present. In this way, a work of the firefighter is efficiently and conveniently assisted, intelligent interactivity of the vehicle-mounted device is greatly enhanced, and linkage control of a plurality of vehicle-mounted devices is realized.

The specific embodiments of the present specification are described above. Other embodiments are within the scope of the appended claims. In some cases, acts or steps recorded in the claims may be performed in an order different from an order in the embodiments and desired results may be still realized. In addition, the processes depicted in the attached drawings do not necessarily require a shown particular order or continuous order to achieve the desired results. In some embodiments, multi-task processing and parallel processing are alternatively possible or may be advantageous.

According to an embodiment of another aspect, a control apparatus for a vehicle-mounted device is provided. FIG. 7 shows a schematic block diagram of the control apparatus according to an embodiment, and the apparatus is the control device in the system architecture shown in FIG. 1, applied to a control system for the vehicle-mounted device, and the control system includes the control device and a vehicle-mounted terminal provided on a vehicle. As shown in FIG. 7, the apparatus 700 includes: an interactive gateway unit 701 and a service control unit 702. Main functions of the constituent units are as follows.

The interactive gateway unit 701 is configured to receive a control message from a first user terminal.

The service control unit 702 is configured to determine, based on the control message, a vehicle-end task matched with the control message; and send information of the vehicle-end task to the vehicle-mounted terminal, so that the vehicle-mounted terminal determines, based on received information of the vehicle-end task, a target vehicle-mounted device from the vehicle-mounted device provided on the vehicle and triggers the target vehicle-mounted device to execute the vehicle-end task.

The interactive gateway unit 701 may be specifically configured to acquire, in response to a voice message from the first user terminal, a text obtained by performing voice recognition on the voice message, and parse a keyword from the text; or, parse, in response to a text message from the first user terminal, a keyword from the text message.

Correspondingly, the service control unit 702 may be specifically configured to determine a vehicle-end task matched with the keyword.

As an implementation, when the service control unit 702 sends information of the vehicle-end task to the vehicle-mounted terminal, if the vehicle-mounted terminal is in a sleep state, the service control unit 702 wakes up the vehicle-mounted terminal, and sends information of the vehicle-end task to the vehicle-mounted terminal; otherwise, the information of the vehicle-end task is directly sent to the vehicle-mounted terminal.

As an implementation, information of the vehicle-end task may include information indicating a type of the vehicle-end task.

Further, the interactive gateway unit 701 may be further configured to acquire an execution result of the vehicle-end task from the vehicle-mounted terminal; and return the execution result to the first user terminal and/or send the execution result to a security database for storage.

As an implementation, the interaction gateway unit 701 may be further configured to send the execution result to the security database for matching, where blacklist data is stored in the security database, and send a matching result, between the execution result and the blacklist data, returned by the security database to the first user terminal.

As another implementation, the service control unit 702 may further be configured to determine, based on the execution result acquired by the interactive gateway unit 701, whether to trigger other vehicle-end tasks, and send, when the other vehicle-end tasks are determined to be triggered, information of another vehicle-end task triggered to the vehicle-mounted terminal.

When the service control unit 702 determines, based on the execution result, whether to trigger other vehicle-end tasks, the matching result may be obtained by matching the execution result in the security database to obtain a matching result by the interaction gateway unit 701. If the matching result meets a triggering condition of other vehicle-end tasks, the service control unit 702 determines to trigger other vehicle-end tasks; otherwise, other vehicle-end tasks are determined not to be triggered.

As yet another implementation, the interactive gateway unit 701 may further be configured to send, in response to a query message from a second user terminal, a query request to the security database, where the query message includes a query condition; acquire a query result returned by the security database, and return the query result to the second user terminal.

The vehicle may be a special vehicle. The vehicle-end task may include one or more of a data acquisition task, a recording task, a traffic control task, a detection task, a warning task, a communication task, and a rescue task.

A target vehicle-mounted device corresponding to the data acquisition task includes a vehicle-mounted sensor device; a target vehicle-mounted device corresponding to the recording task includes a vehicle-mounted recording device; a target vehicle-mounted device corresponding to the traffic control task includes a vehicle-mounted traffic control device; a target vehicle-mounted device corresponding to the detection task includes a vehicle-mounted detection device; a target vehicle-mounted device corresponding to the warning task includes a vehicle-mounted warning device; a target vehicle-mounted device corresponding to the communication task includes a vehicle-mounted communication device; and a target vehicle-mounted device corresponding to the rescue task includes a vehicle-mounted rescue device.

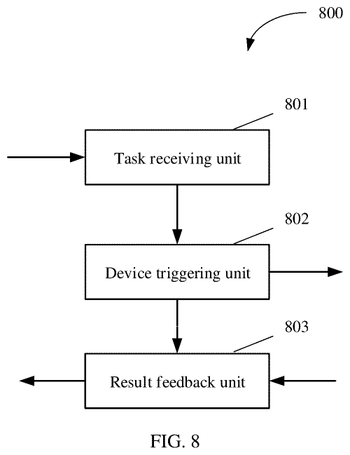

According to an embodiment of still another aspect, an apparatus provided on a vehicle-mounted terminal is provided. FIG. 8 shows a schematic block diagram of the apparatus according to an embodiment. The apparatus is provided on the vehicle-mounted terminal in the system architecture shown in FIG. 1, and may be implemented in a form of a client, and the client may be implemented by means of an AI assistant, an AI robot, and the like. As shown in FIG. 8, the apparatus 800 includes a task receiving unit 801 and a device triggering unit 802, and may further include a result feedback unit 803. Main functions of the constituent units are as follows.

The task receiving unit 801 is configured to receive information of a vehicle-end task sent by a control apparatus, where the vehicle-end task is matched with a control message received by the control apparatus from a first user terminal.

The device triggering unit 802 is configured to determine, based on the information of the vehicle-end task, a target vehicle-mounted device; and trigger the target vehicle-mounted device to execute the vehicle-end task.

As an implementation, the result feedback unit 803 may be configured to acquire an execution result of the vehicle-end task and return the execution result to the control apparatus.

As an implementation, a driver of each vehicle-mounted device may be preset in the vehicle-mounted terminal. A driving program configured to call a target vehicle-mounted device corresponding to the driving program may be stored in the device triggering unit 802, and may be performed to set a parameter on the target vehicle-mounted device, where the parameter is used for the target vehicle-mounted device to execute a corresponding vehicle-end task.

The various embodiments in the specification are described in a progressive manner, and the same or similar parts between the various embodiments may be referred to each other, and each embodiment focuses on a difference from other embodiments. In particular, for the embodiments of the apparatus, since the embodiments of the apparatus are basically similar to the method embodiments, description of the apparatus is relatively simple. Please refer to partial explanation of method embodiments for relevant details. The apparatus embodiments described above are only schematic, a unit described as separate components may or may not be physically separate, and components displayed as a unit may or may not be a physical unit, that is, may be located in one place, or may alternatively be distributed on multiple network units. Some or all of the modules may be selected based on an actual need to achieve the purpose of the embodiment. A person of ordinary skill in the art may understand and implement the foregoing without involving any inventive effort.

The embodiment of the present disclosure further provides a non-transitory storage medium. The storage medium stores one or more computer instruction, and the one or more computer instructions are used to implement the control method provided in the embodiments of the present disclosure.

The above control method may be a method executed by a control device, and the method includes: determining, in response to a control message from a first user terminal, a vehicle-end task matched with the control message; and sending information of the vehicle-end task to a vehicle-mounted terminal, so that the vehicle-mounted terminal determines a target vehicle-mounted device from a vehicle-mounted device provided on a vehicle based on received information of the vehicle-end task and triggers the target vehicle-mounted device to execute the vehicle-end task.

The above method may alternatively be a method executed by a vehicle-mounted terminal, and the method includes: receiving information of a vehicle-end task sent by a control device, where the vehicle-end task is matched with a control message received by the control device from a first user terminal; determining, based on the information of the vehicle-end task, a target vehicle-mounted device; and triggering the target vehicle-mounted device to execute the vehicle-end task.

The embodiments of the present disclosure may be implemented by various means such as a hardware, a firmware, a software, or a combination thereof. In a hardware configuration mode, a method according to an exemplary embodiment of the present disclosure may be implemented by one or more disclosure specific integrated circuits (ASIC), digital signal processors (DSP), digital signal processing device (DSPD), programmable logic devices (PLD), field programmable gate arrays (FPGAs), processors, controllers, microcontrollers, microprocessors, and the like.

In a firmware or software configuration mode, embodiments of the present disclosure may be implemented in a form of modules, processes, functions, and the like. The software code may be stored in a memory unit and executed by a processor. For example, the processor may run the functional units included in FIG. 7 or FIG. 8 and implement processing performed by the functional units. The memory unit is located inside or outside the processor and may send data to and receive data from the processor via various known means.

The foregoing description of the disclosed embodiments enables those skilled in the art to implement or use the present disclosure. Various modifications to these embodiments are apparent to those skilled in the art, and general principles defined herein may be implemented in other embodiments without departing from the spirit or scope of the present disclosure. Therefore, the present disclosure is not limited to these embodiments shown herein, but is to be accorded the widest scope consistent with the principles and novel features disclosed herein.

Although the present disclosure is described above, the present disclosure is not limited thereto. Any person skilled in the art can make various changes and modifications without departing from the spirit and scope of the present disclosure, and therefore, the scope of protection of the present disclosure shall be subject to the scope defined by the claims.

What is claimed is:

1. A control system for a vehicle-mounted device, comprising: a control device and a vehicle-mounted terminal provided on a vehicle;
wherein the control device is configured to receive a control message from a first user terminal, determine a vehicle-end task matched with the control message, and send information of the vehicle-end task to the vehicle-mounted terminal; and
the vehicle-mounted terminal is configured to determine, based on the information of the vehicle-end task, a target vehicle-mounted device for executing the vehicle-end task from vehicle-mounted devices provided on the vehicle, and trigger the target vehicle-mounted device to execute the vehicle-end task.

2. The control system according to claim 1, wherein the vehicle-mounted terminal is further configured to acquire an execution result of the vehicle-end task, and return the execution result to the control device; and
the control device is further configured to acquire the execution result of the vehicle-end task returned by the vehicle-mounted terminal, and return the execution result to the first user terminal and/or send the execution result to a security database for storage.

3. The control system according to claim 2, wherein the control device is further configured to send the execution result to the security database storing blacklist data for matching, and send a matching result, between the execution result and the blacklist data, returned by the security database to the first user terminal.

4. The control system according to claim 2, wherein the control device is further configured to determine, based on the execution result, whether to trigger other vehicle-end tasks, and send, when the other vehicle-end tasks are determined to be triggered, information of another vehicle-end task triggered to the vehicle-mounted terminal.

5. The control system according to claim 1, wherein the control device is started along with a start of an engine of the vehicle, and maintains in a running state.

6. The control system according to claim 2, wherein the control device is further configured to receive a query message from a second user terminal, send a query request to the security database based on a query condition included in the query message, and return a query result acquired from the security database to the second user terminal.

7. The control system according to claim 1, wherein the control device and the first user terminal interact through a dedicated communication network.

8. The control system according to claim 1, wherein the vehicle is a special vehicle; and the vehicle-end task comprises one or more of a data acquisition task, a recording task, a traffic control task, a detection task, a warning task, a communication task, and a rescue task, wherein
a target vehicle-mounted device corresponding to the data acquisition task comprises a vehicle-mounted sensor device;
a target vehicle-mounted device corresponding to the recording task comprises a vehicle-mounted recording device;
a target vehicle-mounted device corresponding to the traffic control task comprises a vehicle-mounted traffic control device;
a target vehicle-mounted device corresponding to the detection task comprises a vehicle-mounted detection device;
a target vehicle-mounted device corresponding to the warning task comprises a vehicle-mounted warning device;
a target vehicle-mounted device corresponding to the communication task comprises a vehicle-mounted communication device; and
a target vehicle-mounted device corresponding to the rescue task comprises a vehicle-mounted rescue device.

9. A control method for a vehicle-mounted device, applied to a control device comprised in a control system, wherein the control device is provided on a vehicle, the control system further comprises a vehicle-mounted terminal provided on the vehicle, and the method comprises:
determining, in response to a control message from the first user terminal, a vehicle-end task matched with the control message; and
sending information of the vehicle-end task to the vehicle-mounted terminal, so that the vehicle-mounted terminal determines a target vehicle-mounted device from vehicle-mounted devices provided on the vehicle based on the information of the vehicle-end task and triggers the target vehicle-mounted device to execute the vehicle-end task.

10. The method according to claim 9, wherein the determining, in response to a control message from the first user terminal, a vehicle-end task matched with the control message comprises:
acquiring, in response to a voice message from the first user terminal, a text obtained by performing voice recognition on the voice message, parsing a keyword from the text, and determining the vehicle-end task matched with the keyword; or
parsing, in response to a text message from the first user terminal, a keyword from the text message, and determining the vehicle-end task matched with the keyword.

11. The method according to claim 9, wherein the sending information of the vehicle-end task to the vehicle-mounted terminal comprises:
waking up the vehicle-mounted terminal and sending the information of the vehicle-end task to the vehicle-mounted terminal when the vehicle-mounted terminal is in a sleep state; or
directly sending the information of the vehicle-end task to the vehicle-mounted terminal when the vehicle-mounted terminal is not in the sleep state;
wherein the information of the vehicle-end task comprises information indicating a vehicle-end task type.

12. The method according to claim 9, further comprising:
acquiring an execution result of the vehicle-end task from the vehicle-mounted terminal; and
returning the execution result to the first user terminal and/or sending the execution result to a security database for storage.

13. The method according to claim 12, further comprising:
sending the execution result to the security database for matching, wherein blacklist data is stored in the security database; and
sending a matching result, between the execution result and the blacklist data, returned by the security database to the first user terminal.

14. The method according to claim 12, further comprising:
determining, based on the execution result, whether to trigger other vehicle-end tasks; and
sending, when the other vehicle-end tasks are determined to be triggered, information of another vehicle-end task triggered to the vehicle-mounted terminal.

15. The method according to claim 1, wherein the determining, based on the execution result, whether to trigger other vehicle-end tasks comprises:
performing matching on the execution result in the security database to obtain a matching result; and
determining to trigger another vehicle-end task when the matching result meets a trigger condition of the another vehicle-end task; or determining not to trigger other vehicle-end tasks when the matching result does not meet any trigger condition of other vehicle-end tasks.

16. The method according to claim 12, further comprising:
sending, in response to a query message from a second user terminal, a query request to the security database, wherein the query message comprises a query condition;
acquiring a query result returned by the security database; and
returning the query result to the second user terminal.

17. The method according to claim 9, wherein the vehicle is a special vehicle; and the vehicle-end task comprises one or more of a data acquisition task, a recording task, a traffic control task, a detection task, a warning task, a communication task, or a rescue task, wherein
a target vehicle-mounted device corresponding to the data acquisition task comprises a vehicle-mounted sensor device;
a target vehicle-mounted device corresponding to the recording task comprises a vehicle-mounted recording device;
a target vehicle-mounted device corresponding to the traffic control task comprises a vehicle-mounted traffic control device;
a target vehicle-mounted device corresponding to the detection task comprises a vehicle-mounted detection device;
a target vehicle-mounted device corresponding to the warning task comprises a vehicle-mounted warning device;
a target vehicle-mounted device corresponding to the communication task comprises a vehicle-mounted communication device; and
a target vehicle-mounted device corresponding to the rescue task comprises a vehicle-mounted rescue device.

18. A control apparatus for a vehicle-mounted device, applied to a control system of the vehicle-mounted device, wherein the control system comprises the control device and a vehicle-mounted terminal provided on a vehicle, and the control apparatus comprises:
an interactive gateway unit, configured to receive a control message from a first user terminal; and
a service control unit, configured to determine, based on the control message, a vehicle-end task matched with the control message; and send information of the vehicle-end task to the vehicle-mounted terminal, so that the vehicle-mounted terminal determines, based on the information of the vehicle-end task, a target vehicle-mounted device from vehicle-mounted devices provided on the vehicle, and triggers the target vehicle-mounted device to execute the vehicle-end task.

19. An electronic device, comprising at least one memory and at least one processor, wherein the memory stores one or more computer instructions, and the one or more computer instructions are executed by the processor to implement the control method for the vehicle-mounted device according to claim 9.

20. A non-transitory storage medium, wherein one or more computer instructions are stored in the non-transitory storage medium for implementing the control method for the vehicle-mounted device according to claim 9.
